(19) United States
(12) Patent Application Publication
(10) Pub. No.: US 2004/0145597 A1
(43) Pub. Date: Jul. 29, 2004

(54) Driving method for electro-optical device, electro-optical device, and electronic apparatus

(75) Inventor: Akihiko Ito, Nagano-ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/743,719

(22) Filed: Dec. 24, 2003

(30) Foreign Application Priority Data
Jan. 29, 2003 (JP) 2003-020432

(51) Int. Cl. G09G 5/10

(52) U.S. Cl. 345/690

(57) ABSTRACT

To enhance the gradation characteristics of sub-field driving in order to further enhance the display quality one frame is divided into a plurality of sub-fields SF1 to SF3. Voltage values V, as voltage data for the corresponding sub-fields that is supplied to pixels, are selected from among voltage values V0 to V9 in accordance with gradation data D0 to D5. Gradation display of the pixels is performed by supplying the voltage values V set for the corresponding sub-fields to the pixels. The voltage values V are selected in such a manner that the amount of change in voltages between adjacent sub-fields is one step level or less. Thus, the amount of change in voltages between adjacent sub-fields is minimized.

### BACKGROUND OF THE INVENTION

1. Field of Invention

The present invention relates to a driving method for an electro-optical device, an electro-optical device, and an electronic apparatus, and more particularly, to gradation control by sub-field driving.

2. Description of Related Art

In order to exploit the merits of pulse width modulation and voltage modulation, gradation display technologies using these modulation systems at the same time have been proposed in the related art. For example, Japanese Unexamined Patent Application Publication No. 5-100629 discloses a technology, in an active matrix electro-optical device, of variably setting the width and height of voltage pulses in accordance with gradation data and supplying the pulses to pixels. Also, Japanese Unexamined Patent Application Publication No. 2001-100700 discloses a technology, for sub-field driving, which is a type of pulse width modulation system, of assigning weights to sub-fields by variably setting the levels of a plurality of types of on-state voltages to turn on pixels.

Gradation to be actually displayed is determined not only by the time ratio (duty ratio) of voltage levels within a predetermined time period but also is influenced by the amount of change in the voltages between adjacent sub-fields. In other words, even for the same duty ratio, actual display gradations are different depending on the amount of change in the voltage levels between adjacent sub-fields. As a result of this, especially for multiple gradations, gradation inversion and gradation collapse are significant, and high-quality display is thus impossible.

### SUMMARY OF THE INVENTION

The present invention is designed to address such circumstances. The present invention enhances display quality by enhancing the gradation characteristics of sub-field driving.

In order to achieve the above, a first aspect of the invention provides a driving method for an electro-optical device that performs gradation display of pixels by using a plurality of sub-fields defined by dividing a predetermined period while suppressing the amount of change in data between adjacent sub-fields. The driving method includes a first step of setting level values, as data for the corresponding sub-fields that is supplied to the pixels, by selecting the level values from among three or more different level values in accordance with gradation data. The driving method also includes a second step of performing the gradation display of the pixels by supplying the data set for the corresponding sub-fields to the pixels. Here, in the first step, the level values are selected in such a manner that the absolute value of the amount of change in data between adjacent sub-fields is a predetermined amount of change or less. For example, by setting the predetermined amount of change to one step level corresponding to the amount of change between the level values that are adjacent to each other, the amount of change in data between adjacent sub-fields can be minimized.

A second aspect of the invention provides a driving method for an electro-optical device that performs gradation display of pixels by using a plurality of sub-fields defined by dividing a predetermined period. The driving method includes a first step of setting level values, as data for the corresponding sub-fields that is supplied to the pixels, by selecting the level values from among three or more different level values in accordance with gradation data. The driving method also includes a second step of performing the gradation display of the pixels by supplying the data set for the corresponding sub-fields to the pixels. In the first step, setting of the level values for the series of sub-fields is focused on, and the level values that are adjacent to each other are selected.

A third aspect of the invention provides a driving method for an electro-optical device that performs gradation display of pixels by using a plurality of sub-fields defined by dividing a predetermined period. The driving method includes a first step of selecting level values, as data for the corresponding sub-fields that is supplied to the pixels, from among three or more different level values in accordance with gradation data. The driving method also includes a second step of performing the gradation display of the pixels by supplying the data set for the corresponding sub-fields to the pixels. In the first step, a change in the level values according to a change in gradations is focused on, and the level values are changed within the adjacent level values in accordance with an increase of gradation values defined by the gradation data.

Here, in any one of the first to third aspects of the invention, the data may be a data voltage and the level values may be set by voltage values. Alternatively, the data may be a data current and the level values may be set by current values.

A fourth aspect of the invention provides a driving method for an electro-optical device that performs gradation display of pixels by using a plurality of sub-fields defined by dividing a predetermined period. The invention relates to sub-field driving in an electro-optical device in which data write to pixels each including an electro-optical element of a current-driven type, such as an organic EL element, is performed by a current program system. More specifically, the driving method includes a first step of setting level values, as data for the corresponding sub-fields that is supplied to the pixels, by selecting the level values from among a plurality of different level values in accordance with gradation data. The driving method also includes a second step of writing the data to the pixels by supplying the data set for the corresponding sub-fields to the pixels by current levels and a third step of performing the gradation display of the pixels by setting driving currents corresponding to the data written to the pixels and by supplying the set driving currents to electro-optical elements that emit light at brightnesses corresponding to the driving currents.

A fifth aspect of the invention provides an electro-optical device that performs gradation display of pixels by using a plurality of sub-fields defined by dividing a predetermined period while suppressing the amount of change in data between adjacent sub-fields. The electro-optical device includes a plurality of scanning lines, a plurality of data lines, and a plurality of pixels provided in accordance with crossing of the scanning lines and the data lines. The electro-optical device also includes a scanning line driving circuit that selects one of the scanning lines corresponding to one of the pixels to which data is written by outputting a scanning signal to the one of the scanning lines and a data conversion circuit that generates the data for the corresponding sub-fields by converting gradation data. The electro-optical device also includes a data line driving circuit that cooperates with the scanning line driving circuit and that outputs the data for the corresponding sub-fields, the data being generated by the data conversion circuit, to one of the data lines corresponding to the one of the pixels to which the data is written. The data conversion circuit sets level values, as the data for the corresponding sub-fields, by selecting the level values from among three or more different level values in such a manner that the amount of change in data between adjacent sub-fields is a predetermined amount of change or less. For example, by setting the predetermined amount of change to one step level corresponding to the amount of change between the level values that are adjacent to each other, the amount of change in data between adjacent sub-fields can be minimized.

A sixth aspect of the invention provides an electro-optical device that performs gradation display of pixels by using a plurality of sub-fields defined by dividing a predetermined period. The electro-optical device includes a plurality of scanning lines, a plurality of data lines, and a plurality of pixels provided in accordance with crossing of the scanning lines and the data lines. The electro-optical device also includes a scanning line driving circuit that selects one of the scanning lines corresponding to one of the pixels to which data is written by outputting a scanning signal to the one of the scanning lines and a data conversion circuit that generates the data for the corresponding sub-fields by converting gradation data. The electro-optical device also includes a data line driving circuit that cooperates with the scanning line driving circuit and that outputs the data for the corresponding sub-fields, the data being generated by the data conversion circuit, to one of the data lines corresponding to the one of the pixels to which the data is written. In the data conversion circuit, setting of the level values, as the data for the corresponding sub-fields, for the series of sub-fields is focused on, and the level values are set by selecting the level values from among three or more different level values in such a manner that the level values are adjacent to each other.

A seventh aspect of the invention provides an electro-optical device that performs gradation display of pixels by using a plurality of sub-fields defined by dividing a predetermined period. The electro-optical device includes a plurality of scanning lines, a plurality of data lines, and a plurality of pixels provided in accordance with crossing of the scanning lines and the data lines. The electro-optical device also includes a scanning line driving circuit that selects one of the scanning lines corresponding to one of the pixels to which data is written by outputting a scanning signal to the one of the scanning lines and a data conversion circuit that generates the data for the corresponding sub-fields by converting gradation data. The electro-optical device also includes a data line driving circuit that cooperates with the scanning line driving circuit and that outputs the data for the corresponding sub-fields, the data being generated by the data conversion circuit, to one of the data lines corresponding to the one of the pixels to which the data is written. The data conversion circuit selects the data for the corresponding sub-fields from among three or more different level values and changes the level values within the adjacent level values in accordance with an increase of gradation values defined by the gradation data.

Here, in any one of the fifth to seventh aspects of the invention, the data line driving circuit may output the data for the corresponding sub-fields to the one of the data lines by voltage levels. In this case, the one of the pixels may include, for example, a switching element whose conduction is controlled by the scanning signal for the one of the scanning lines and an electro-optical element. The electro-optical element includes a pair of electrodes and liquid crystal held between the pair of electrodes. The transmittance or the reflectance of the electro-optical element is changed in accordance with the data supplied by voltage levels from the one of the data lines via the switching element. Alternatively, the one of the pixels may include, for example, a switching element whose conduction is controlled by the scanning signal for the one of the scanning lines, a holding device to hold the data supplied by voltage levels from the one of the data lines via the switching element, a driving element that generates corresponding driving currents in accordance with the data held by the holding device, and an electro-optical element that emits light at brightnesses corresponding to the driving current.

Also, in any one of the fifth to seventh aspects of the invention, the data line driving circuit may output the data for the corresponding sub-fields to the one of the data lines by current levels. In this case, the one of the pixels may include, for example, a switching element whose conduction is controlled by the scanning signal for the one of the scanning lines, a holding device to hold the data supplied by current levels from the one of the data lines via the switching element as data of voltage levels, a driving element that generates corresponding driving currents in accordance with the data held by the holding device, and an electro-optical element that emits light at brightnesses corresponding to the driving current.

An eighth aspect of the invention provides an electro-optical device that performs gradation display of pixels by using a plurality of sub-fields defined by dividing a predetermined period. The aspect of the invention relates to sub-field driving in an electro-optical device in which data written to pixels each including an electro-optical element of a current-driven type, such as an organic EL element, is performed by a current program system. More specifically, the electro-optical device includes a plurality of scanning lines, a plurality of data lines, and a plurality of pixels provided in accordance to crossing of the scanning lines and the data lines. The electro-optical device also includes a scanning line driving circuit that selects one of the scanning lines corresponding to one of the pixels to which data is written by outputting a scanning signal to the one of the scanning lines and a data conversion circuit that selects level values, as the data for the corresponding sub-fields that is supplied to the pixels, by selecting the level values from among a plurality of level values of different voltage values in accordance with gradation data. The electro-optical device also includes a data line driving circuit that cooperates with the scanning line driving circuit and that outputs, by current levels, the data of voltage levels for the corresponding sub-fields, the data being generated by the data conversion circuit and being converted into data of current levels, to one of the data lines corresponding to the one of the pixels to which the data is written. Each of the pixels includes a holding device to hold the data, a driving element that sets corresponding driving currents in accordance with the data held in the holding device, and an electro-optical element that emits light at brightnesses corresponding to the set driving currents.

A ninth aspect of the invention provides an electronic apparatus provided with the electro-optical device as set forth in any one of the fifth to eighth aspects of the invention.

### BRIEF DESCRIPTION OF THE DRAWINGS

FIG. 1 is an illustration for explaining sub-field driving according to a first exemplary embodiment;

FIG. 2 is a characteristic schematic showing the relationship between effective voltage and relative transmittance (reflectance);

FIG. 3 is a voltage setting table for sub-fields according to the first exemplary embodiment;

FIG. 4 is a block schematic of an electro-optical device according to the first exemplary embodiment;

FIG. 5 is an equivalent circuit schematic of a pixel using a liquid crystal element;

FIG. 6 is a block schematic of a data conversion circuit;

FIG. 7 is a block schematic of a data line driving circuit;

FIG. 8 is a block schematic of a voltage selection circuit;

FIG. 9 is a timing chart for display control by line sequential scanning;

FIG. 10 is an illustration for explaining sub-field driving according to a second exemplary embodiment;

FIG. 11 is a voltage setting table for sub-fields according to the second exemplary embodiment;

FIG. 12 is an illustration for explaining sub-field driving according to a third exemplary embodiment;

FIG. 13 is a voltage setting table for sub-fields according to the third exemplary embodiment;

FIG. 14 is an equivalent circuit schematic of a pixel according to a fourth exemplary embodiment; and

FIG. 15 is an equivalent circuit schematic of a pixel according to a fifth exemplary embodiment.

### DETAILED DESCRIPTION OF EXEMPLARY EMBODIMENTS

First Exemplary Embodiment

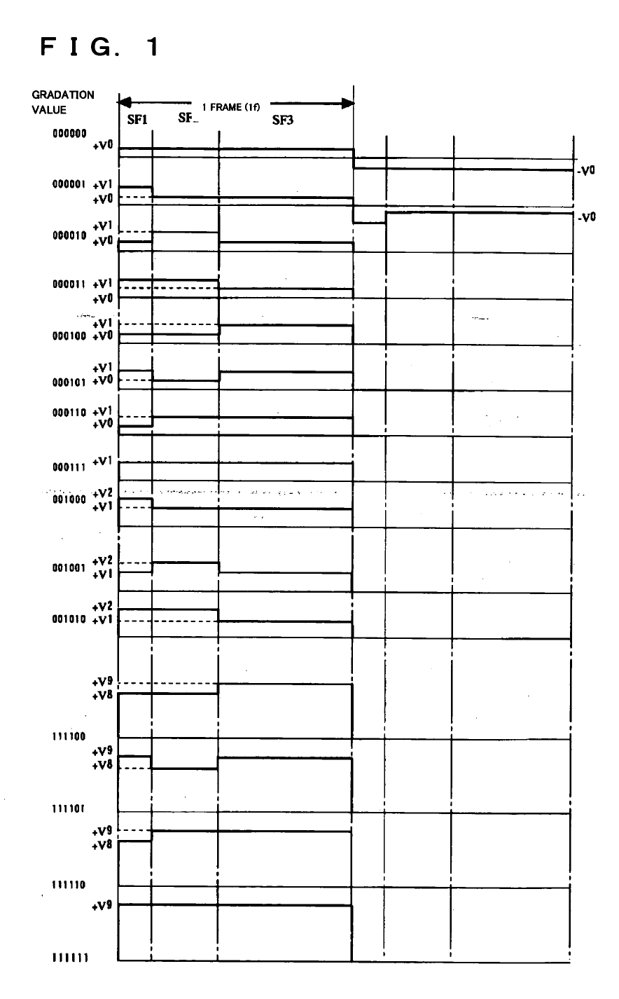

Before specifically explaining an electro-optical device according to a first exemplary embodiment, the general outlines of sub-field driving in the first exemplary embodiment will be described. FIG. 1 is an illustration for explaining sub-field driving for a liquid crystal element. In FIG. 1, the relationship between a voltage applied to a pixel and gradation data is shown for each sub-field. In general, in a case where a liquid crystal element is used as an electro-optical element in a pixel, data is supplied to the pixel at a voltage level. Also, AC driving in which the level of the voltage polarity is inverted at predetermined intervals (for example, for every one frame) increases the longevity of liquid crystal.

Gradation data that defines display gradation of a pixel is, for example, 64-gradation data composed of 6 bits, D0 to D5. One frame (1 f) is composed of three sub-fields, SF1 to SF3. In the relationship with gradation to be displayed, the sub-fields SF1, SF2, and SF3 have lengths (display periods) provided with weights of 1:2:4, respectively. However, weighting for the sub-fields SF1, SF2, and SF3 may be appropriately adjusted, for example, to 1.0:2.1:3.9, in accordance with the characteristics of liquid crystal.

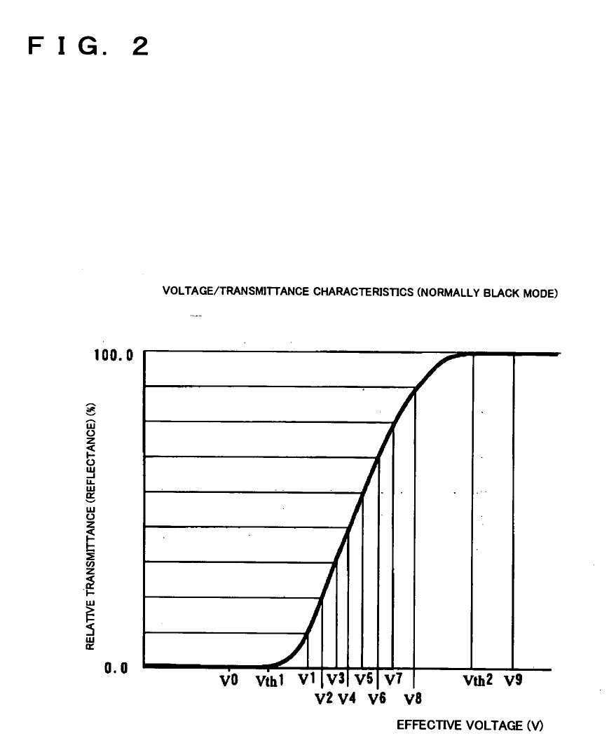

A piece of data for each of the sub-fields SF that is supplied to a pixel is determined from among three or more different level values. For a case where data is set by a voltage level, the level value is also set by a voltage value. In the first exemplary embodiment, as shown in FIG. 2, ten different discrete voltage values, V0 to V9, are prepared. The voltage values V0 to V9 are set in such a manner that the optical characteristics (relative transmittance (or relative reflectance)) of liquid crystal operating in a normally black mode change at substantially regular intervals. The relative transmittance is normalized on the basis of setting 0% as the minimum value of transmitted light volume and setting 100% as the maximum value of transmitted light volume. As shown in FIG. 2, the transmittance obtained in an area in which an effective voltage is lower than a threshold voltage Vth1 is 0%. Thus, the voltage value V0, which is a complete off-state voltage, is set to a value lower than the threshold voltage Vth1. Here, it is preferable that the voltage value V0 be set in such a manner that the amount of change in voltages between the voltage value V0 and the adjacent voltage value V1 is as small as possible. In contrast, the transmittance obtained in an area in which an effective voltage is higher than a saturation voltage Vth2 is 100%. Thus, the voltage value V9, which is a complete on-state voltage, is set to a value higher than the saturation voltage Vth2. Here, it is preferable that the voltage value V9 be set in such a manner that the amount of change in voltages between the voltage value V9 and the adjacent voltage value V8 is as small as possible. Also, in an area from the threshold voltage Vth1 to the saturation voltage Vth2, the transmittance increases nonlinearly in accordance with an increase of the effective voltage. Thus, although the medium voltage values V1 to V8 are set in such a manner that the transmittance changes at substantially regular intervals in the area between the threshold voltage Vth1 and the saturation voltage Vth2, the voltage values V1 to V8 may be set in such a manner that the transmittance changes nonlinearly. Accordingly, setting of level values (voltage values) can be flexibly applied to various types of liquid crystal.

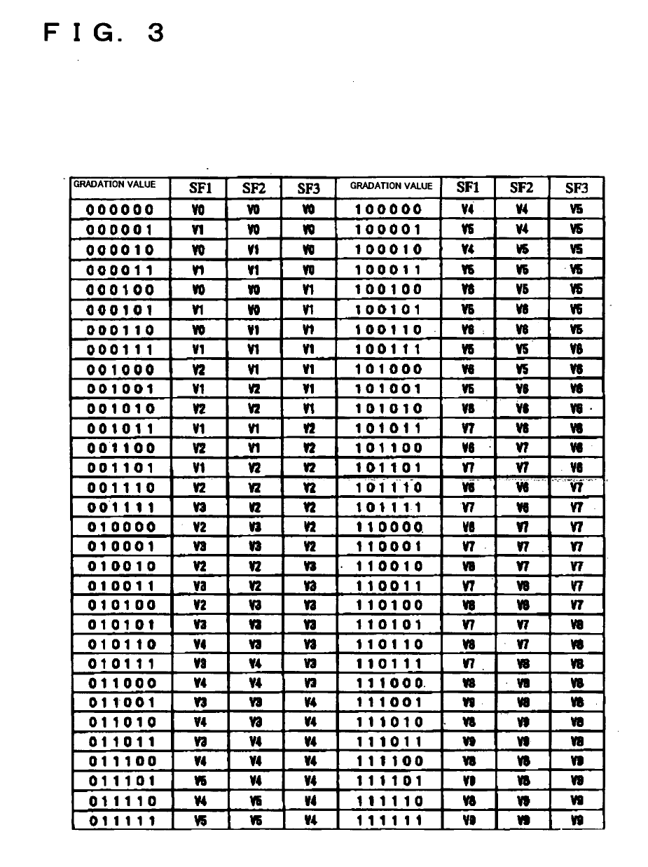

FIG. 3 is a voltage setting table for the sub-fields SF1 to SF3. The voltage value for each of the sub-fields SF is uniquely specified in accordance with the gradation data D0 to D5. Thus, in view of the whole one frame composed of the three sub-fields SF1 to SF3, the combination of three voltage values selected from among the voltage values V0 to V9 is also uniquely specified in accordance with the gradation data D0 to D5. Display gradation of a pixel is determined from the combination of the voltage values in consideration of weighting of the sub-fields SF1 to SF3. For example, if a gradation value (D5D4D3D2D1D0) is “000011”, the voltage value for the first sub-field SF1 is V1, the voltage value for the next sub-field SF2 is also V1, and the voltage value for the last sub-field SF3 is V0. Thus, the ratio (duty ratio) of the periods set for the voltage values V0 and V1 within the one frame period is specified, and gradation display for the pixel is performed at respective effective voltages in response to the time density.

Although the number of divisions of sub-fields SF and the number of set voltage V values are determined appropriately in accordance with the number of gradations to be displayed, the set voltage values must include three or more different voltage values.

The features of the sub-field driving in the first exemplary embodiment are that a voltage value V is selected in such a manner that the amount of change in data (the amount of change in voltages) between adjacent sub-fields (for example, the sub-fields SF1 and SF2) does not exceed a predetermined amount of change (step level). This effectively reduces or prevents gradation deviation, gradation inversion, gradation collapse, and the like caused by a difference in the amount of voltage change. Here, the “step level” means a step interval allowable between the discrete voltage values V0 to V9. For example, the step level between two adjacent voltage values (for example, V0 and V1) is “1” and the step level between two voltage values with a voltage value therebetween (for example, V0 and V2) is “2”. In the first exemplary embodiment, in order to minimize the amount of change in voltages between two adjacent sub-fields, the “predetermined amount of change” is set to “one step level or less”. Thus, two voltage values for adjacent sub-fields must be equal or adjacent to each other. As shown in the voltage setting table in FIG. 3, for all the gradation values, the amount of change in voltages between adjacent sub-fields is one step level or less. As shown in FIG. 2, since the voltage values V0 to V9 have different adjacent intervals, it should be noted that, for example, although the value itself of the voltage difference between the voltage values V0 and V1 is different from that of the voltage difference between the voltage values V1 and V2, the step level of the voltage values V0 and V1 and the step level of the voltage values V1 and V2 are both “1”.

Also, in another point of view of the sub-field driving, there are features that three voltage values for the series of sub-fields SF1 to SF3 are selected from among the voltage values V0 to V9 in such a manner that the selected voltage values are adjacent to each other. However, it should be noted that the voltage values are only needed to be selected so as to be adjacent to each other and that a plurality of voltage values V is not necessarily selected. For example, although, for a gradation value within a range of “000000” to “000111”, the gradation value is basically defined by a combination of the two adjacent voltage values V0 and V1, only one voltage value V0 (or V1) is used for “000000” (or “000111”).

Also, further in another point of view of the sub-field driving, there are features that the voltage values are changed within the adjacent voltage values (for example, V0 and V1) in accordance with an increase of the gradation value defined by the gradation data D0 to D5. For example, if the gradation value is increased from “001000” to “001001”, the sub-field SF1 changes from V2 to V1 and the sub-field SF2 changes from V1 to V2. Thus, the changes of the voltage values are made between the adjacent voltage values. Accordingly, since, irrespective of the gradation value, the amount of change in voltage value V is reduced as the amount of change in gradation value is reduced, the gradation characteristics in animation display based on the premise of a time-series gradation change can be enhanced.

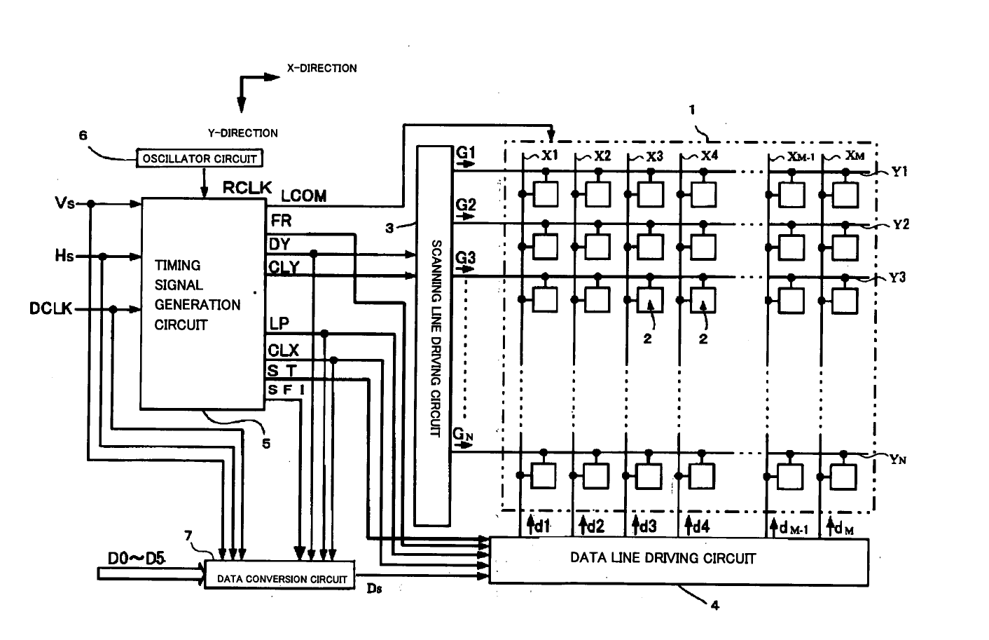

FIG. 4 is a block schematic of the electro-optical device according to the first exemplary embodiment. A display unit 1 is an active matrix display panel in which liquid crystal elements are driven by switching elements, such as field effect transistors (FETs). The display unit 1 includes pixels 2 of M dots×N lines arranged in a matrix (in a two-dimensional plane). Also, the display unit 1 includes N scanning lines Yn (n=1 to N) each extending in the horizontal direction (row direction) and M data lines Xm (m=1 to M) each extending in the vertical direction (column direction), and the pixels 2 are arranged in accordance to crossing of the scanning lines Yn and the data lines Xm.

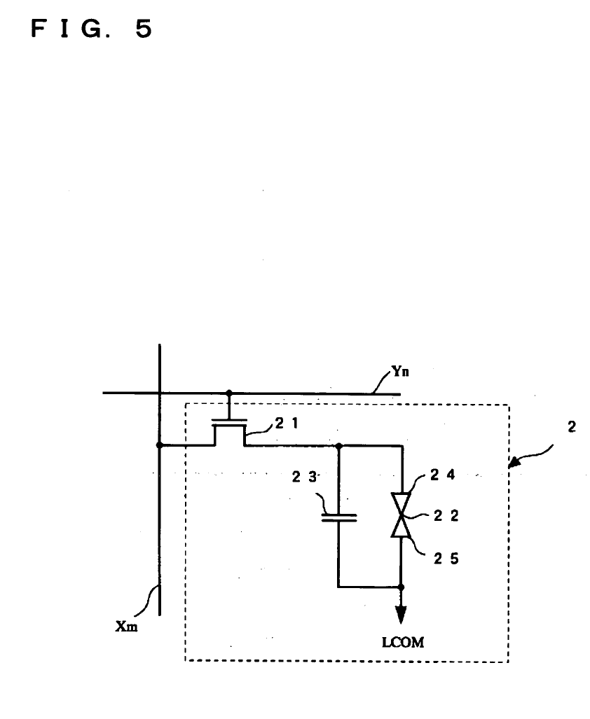

FIG. 5 is an equivalent circuit schematic of one of the pixels 2 made of liquid crystal. Each of the pixels 2 includes a switching transistor 21 functioning as a switching element, a liquid crystal element 22 whose transmittance changes depending on the applied voltage, and a capacitor 23. The source of the switching transistor 21 is connected to one of the data lines Xm and the gate of the switching transistor 21 is connected to one of the scanning lines Yn. For a plurality of pixels 2 located in the same pixel row, the sources of the respective switching transistors 21 are commonly connected to the one of the data lines Xm. Also, for a plurality of pixels 2 located in the same pixel column, the gates of the respective switching transistors 21 are commonly connected to the one of the scanning lines Yn. The drain of each of the switching transistors 21 is commonly connected to the liquid crystal element 22 and the capacitor 23 arranged in parallel. The liquid crystal element 22 includes a pixel electrode 24, a counter electrode 25, and liquid crystal held between the pixel electrode 24 and the counter electrode 25. Data supplied from the one of the data lines Xm is applied to the pixel electrode 24 and one electrode of the capacitor 23 via the switching transistor 21 at a voltage level. Also, a driving voltage LCOM is applied to the counter electrode 25 and the other electrode of the capacitor 23. In the data writing period of each of the sub-fields SF, data supplied to each of the pixels 2 at a voltage level causes charge and discharge of the liquid crystal element 22 and the capacitor 23. Accordingly, the transmittance of the liquid crystal is determined in accordance with the potential difference between the pixel electrode 24 and the counter electrode 25, so that gradation display of each of the pixels 2 is performed.

As shown in FIG. 4, a timing signal generation circuit 5 synchronously controls a scanning line driving circuit 3, a data line driving circuit 4, and a data conversion circuit 7 in accordance with external signals, such as a vertical synchronizing signal Vs, a horizontal synchronizing signal Hs, and a dot clock signal DCLK, input from a host device (not shown). Under such synchronous control, the scanning line driving circuit 3 and the data line driving circuit 4 cooperate to control the display of the display unit 1.

An oscillator circuit 6 generates a basic reading timing clock RCLK and supplies the reading timing clock RCLK to the timing signal generation circuit 5. The timing signal generation circuit 5 generates various internal signals including an alternating signal FR, the driving voltage LCOM, a start pulse DY, a clock signal CLY, a latch pulse LP, a clock signal CLX, a start signal ST, a sub-field signal SFI, and the like, in accordance with the external signals Vs, Hs, and DCLK. Here, the alternating signal FR is a signal whose polarity is inverted at every frame. The driving voltage LCOM is a voltage that is applied to the counter electrode 25 formed on a counter substrate of the display unit 1. In the first exemplary embodiment, the driving voltage LCOM is set to 0 V. In a case where, when scanning signals G1, G2, G3, . . . , GN fall, a pixel voltage is slightly shifted toward lower voltages due to the falling, a DC component is not applied to the liquid crystal by setting the driving voltage LCOM to negative. The start pulse DY is a pulse signal that is output at the start of each of the sub-fields SF. The pulse DY controls changing between the sub-fields. The clock signal CLY is a signal that defines a horizontal scanning period (1H) in the scanning side (Y side). The latch pulse LP is a pulse signal that is output at the start of the horizontal scanning period. The Latch pulse LP is output at the transition of the level of the clock signal CLY, in other words, at the rising edge and the falling edge of the clock signal CLY. The clock signal CLX is a dot clock signal to write data to each of the pixels 2. The start signal ST is a timing signal that defines the time to start to capture data for one pixel row. The sub-field signal SFI is a signal that designates the number of a sub-field and that defines the time to start the designation.

The scanning line driving circuit 3 mainly includes a shift register, an output circuit, and the like. The scanning line driving circuit 3 transfers the start pulse DY, which is supplied at the start of each of the sub-fields, in accordance with the clock signal CLY, and sequentially and exclusively sets the scanning signals G1, G2, G3, . . . , GN for the corresponding scanning lines Y1 to YN to H level. Thus, line sequential scanning is performed in such a manner that a pixel row corresponding to one scanning line is sequentially selected in a predetermined order (generally, from the topmost to the bottommost) in a predetermined period.

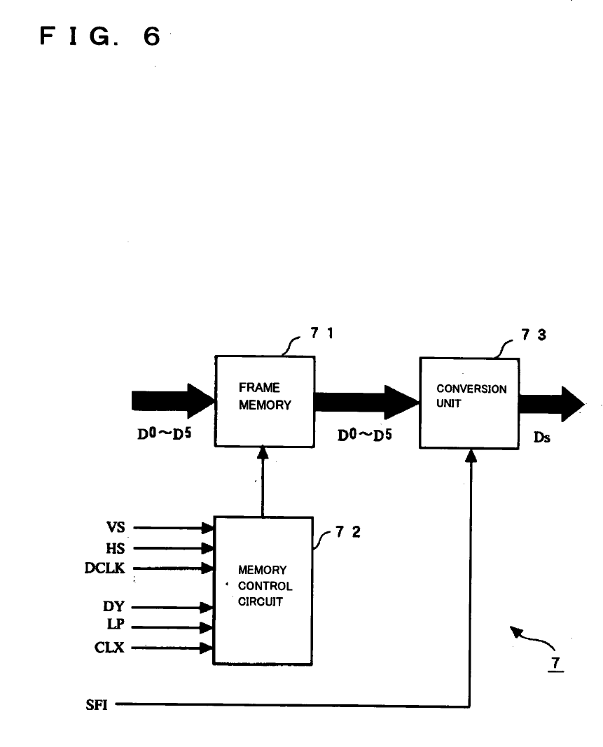

The data conversion circuit 7 converts the input 6-bit gradation data D0 to D5, and outputs 4-bit sub-field data Ds that defines a voltage value V for each of the sub-fields SF to the data line driving circuit 4. FIG. 6 is a block schematic of the data conversion circuit 7. The data conversion circuit 7 includes a frame memory 71, a memory control circuit 72, and a conversion unit 73. The frame memory 71 includes at least a memory space of M×N bits corresponding to the resolution of the display unit 1, and stores and holds, in units of frames, the gradation data D0 to D5 input from the host device. The memory control circuit 72 controls data to be written into the frame memory 71 in accordance with the writing system signals Vs, Hs, and DCLK. In other words, under the control of the two synchronizing signals Vs and Hs, the dot clock signal DCLK is counted up, and the gradation data D0 to D5 is sequentially stored at an address corresponding to the count rate. The count rate is reset at every time when the next vertical synchronizing signal Vs is input, so that new count up is started. Also, the memory control circuit 72 controls data to be read from the frame memory 71, in accordance with the reading system signals DY, LP, and CLX. In other words, under the control of the two pulses DY and LP, the clock signal CLX is counted up, and the gradation data D0 to D5 is sequentially read from an address corresponding to the count rate. The gradation data D0 to D5 read from the frame memory 71 is transferred to the conversion unit 73 in serial. The conversion unit 73 selects a combination of voltage values V corresponding to the gradation data D0 to D5 in accordance with the voltage setting table shown in FIG. 3. Then, the conversion unit 73 outputs, in serial, each piece of the sub-field data Ds, which specifies the selected voltage value, for each of the sub-fields, in the order of the sub-fields designated by the sub-field signal SFI.

In one horizontal scanning period (1H), the data line driving circuit 4 simultaneously outputs 4-bit sub-field data Ds for a pixel row to which data is written in this horizontal scanning period and, at the same time, dot-sequentially latches sub-field data Ds for a pixel row to which data is written in the next horizontal scanning period. In a certain horizontal scanning period, M pieces of sub-field data Ds corresponding to the number of data lines Xm are sequentially latched. Then, in the next horizontal scanning period, the M pieces of latched sub-field data Ds are converted into a voltage value from among the voltage values V0 to V9 and are simultaneously output, as data signals d1, d2, d3, . . . , dM for the voltage level, to the corresponding data lines X1 to XM.

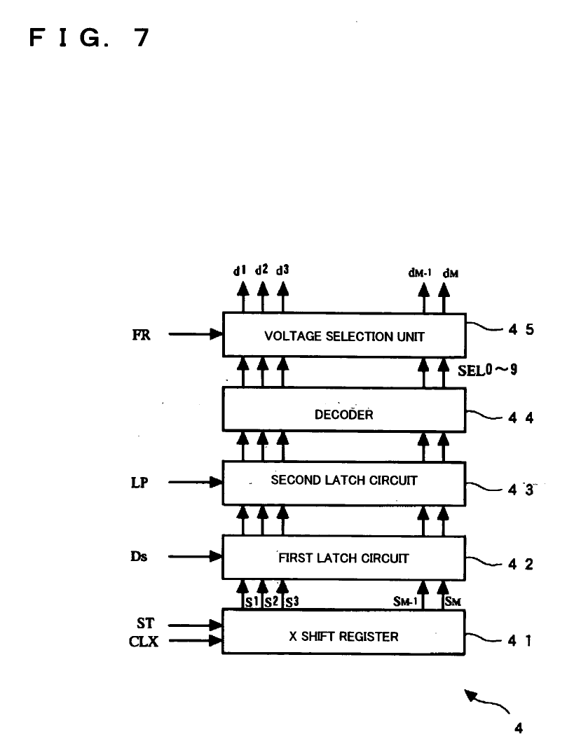

FIG. 7 is a block schematic of the data line driving circuit 4. The data line driving circuit 4 includes an X shift register 41, a first latch circuit 42, and a second latch circuit 43, a decoder 44, and a voltage selection unit 45. The X shift register 41 transfers the start signal ST, which is supplied at the start of the horizontal scanning period, in accordance with the clock signal CLX, and sequentially and exclusively supplies it as a latch signal S1, S2, S3, . . . , SM.

At the falling edge of the latch signals S1, S2, S3, . . . , SM, the first latch circuit 42 sequentially latches 4-bit sub-field data Ds, which is serial data. At the falling edge of the latch pulse LP, the second latch circuit 43 latches the sub-field data Ds latched by the first latch circuit 42 and outputs the latched sub-field data Ds in parallel to the decoder 44. In accordance with the sub-field data Ds sent from the second latch circuit 43, the decoder 44 generates selection signals SEL0 to SEL9 for selecting a voltage value from among the voltage values V0 to V9 (−V0 to −V9) and outputs the selection signals SEL0 to SEL9 to the voltage selection unit 45. The voltage selection unit 45 includes a plurality of voltage selection circuits 45′ provided for each of the data lines Xm. Each of the voltage selection circuits 45′ selects a voltage value from among the voltage values V0 to V9 with polarity inversion (in other words, a voltage value from among the voltage values V0 to V9 or from among voltage values −V0 to −V9) in accordance with the selection signal SEL0 to SEL9, and outputs the selected voltage value V, as a data signal dm, to a corresponding one of the data lines Xm.

An aspect of the present invention is also applicable to a case where data is linear sequentially input directly from the frame memory or the like to the data line driving circuit 4. Since, even in such a case, the operation of principal parts of an aspect of the present invention is similar as described above, the description for the case is omitted in this case, there is no need to provide the X shift register 41 in the data line driving circuit 4.

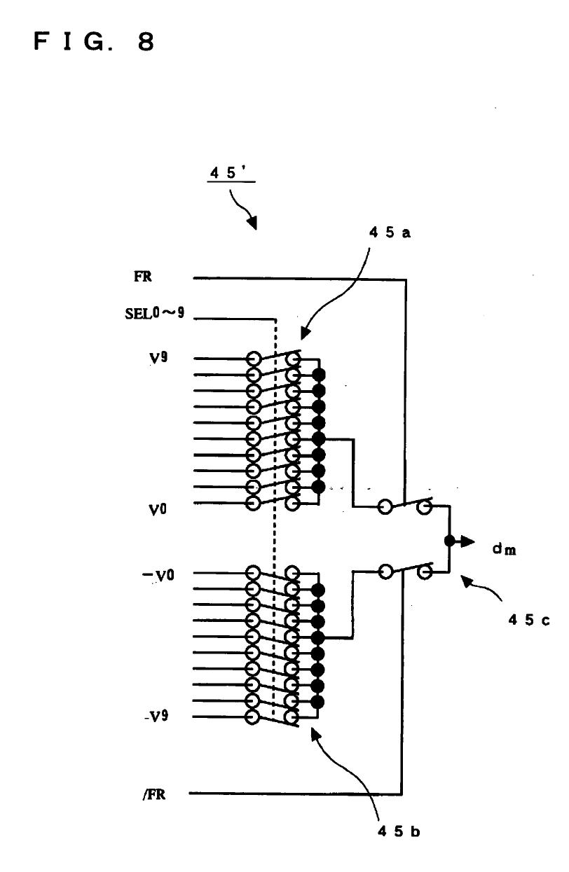

FIG. 8 is a block schematic of one of the voltage selection circuits 45′ corresponding to one of the data lines Xm. Each of the voltage selection circuit 45′ includes three switch groups, a first switch group 45a, a second switch group 45b, and a third switch group 45c. Each of the first switch group 45a, the second switch group 45b, and the third switch group 45c includes, for example, a plurality of analog switches arranged in parallel. One of the analog switches of the first switch group 45a is selectively turned on in accordance with the level of the selection signal SEL0 to SEL9, and outputs a voltage value from among the positive voltage values V0 to V9 to the third switch group 45c. Also, one of the analog switches of the second switch group 45b is selectively turned on in accordance with the level of the selection signal SEL0 to SEL9, and outputs a voltage value from among the negative voltage values −V0 to −V9 to the third switch group 45c. Voltage values selected by the preceding switch groups, the first switch group 45a and the second switch group 45b, have different polarities from each other but have the same absolute value. One of the analog switches of the following switch group, the third switch group 45c, is selectively turned on in accordance with the alternating signal FR or its inversion signal/FR, and outputs any one of the positive voltage value V and the negative voltage value −V as a data signal dm.

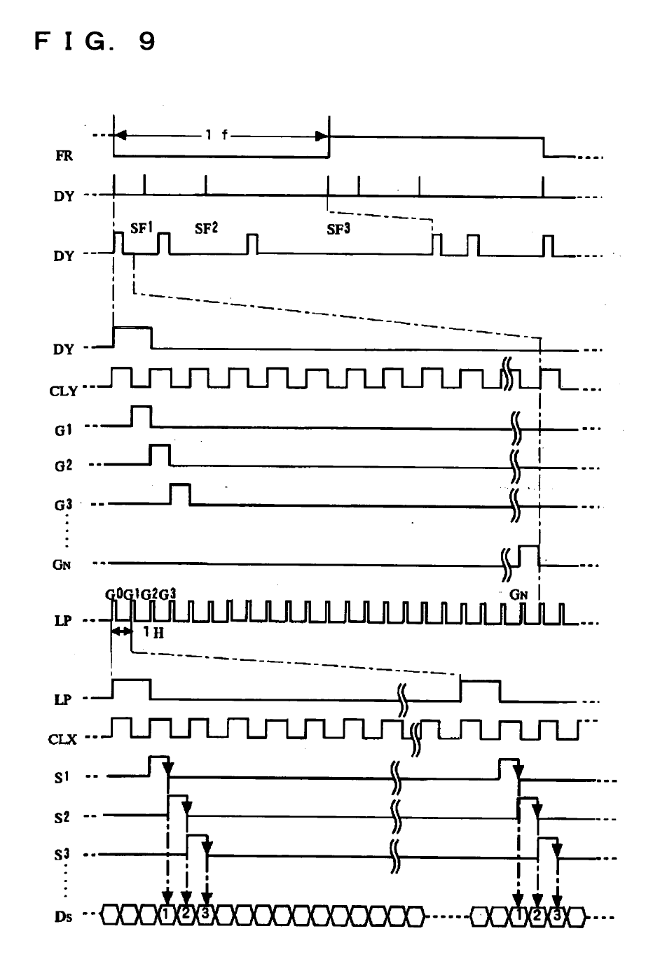

With reference to a timing chart shown in FIG. 9, display control of the display unit 1 by means of linear sequential scanning will now be described. First, in one frame (1 f) in which the alternating signal FR is at L level, the start pulse DY for designating the start of the first sub-field SF1 is supplied to the scanning line driving circuit 3. Then, the scanning line driving circuit 3 performs data transfer in accordance with the clock signal CLY, and exclusively sets the scanning signals G1, G2, G3, . . . , GN at H level in that order. Accordingly, the scanning lines Y1 to YN, located from the topmost to the bottommost in FIG. 4, are sequentially selected.

Each of the scanning signals G1, G2, G3, . . . , GN has a pulse width corresponding to a half period of the clock signal CLY. After the start pulse DY is supplied, the scanning signal G1 is output to the topmost scanning line Y1 with at least a half period of the clock signal CLY delay after the clock signal CLY first rises. Thus, during the time from the supply of the start pulse DY to the output of the scanning signal G1, one shot (G0) of the latch pulse LP is supplied to the data line driving circuit 4. Then, the data line driving circuit 4 performs data transfer in accordance with the clock signal CLX, and sequentially and exclusively outputs the latch signals S1, S2, S3, . . . , SM in the one horizontal scanning period. Each of the latch signals S1, S2, S3, . . . , SM has a pulse width corresponding to a half period of the clock signal CLX.

At the falling edge of the latch signal S1, the first latch circuit 42 shown in FIG. 7 latches the sub-field data Ds for one of the pixels 2 corresponding to crossing of the topmost scanning line Y1 and the leftmost data line X1. Next, at the falling edge of the latch signal S2, the sub-field data Ds for one of the pixels 2 corresponding to crossing of the topmost scanning line Y1 and the second leftmost data line X2 is latched. Then, similarly, at the falling edge of the latch signal Sm, the sub-field data Ds for one of the pixels 2 corresponding to crossing of the topmost scanning line Y1 and the m-th leftmost data line Xm is sequentially latched. Accordingly, M pieces of sub-field data Ds for the pixel row corresponding to the topmost scanning line Y1 are dot-sequentially latched by the first latch circuit 42.

Then, when the clock signal CLY falls, the scanning signal G1 becomes at H level, and the topmost scanning line Y1 is selected. Thus, all the switching transistors 21 for the topmost pixel row corresponding to the scanning line Y1 are tuned on at the same time. In contrast, in synchronization with the falling of the clock signal CLY, the next latch pulse LP is output. At the falling edge of the latch pulse LP, the second latch circuit 43 simultaneously outputs the M pieces of sub-field data Ds dot-sequentially latched by the first latch circuit 42 to the decoder 44. Also, at this time, the decoder 44 generates M selection signals SEL0 to SEL9 from the M pieces of sub-field data Ds, and simultaneously outputs the selection signals SEL0 to SEL9 to the corresponding voltage selection circuits 45′. In a case where the alternating signal FR is at L level, the voltage selection circuits 45′ supply negative voltage values (−V) at the same time as data signals Dms to the corresponding data lines Xm in accordance with the selection signals SEL0 to SEL9. Thus, the voltage values V, as data, are applied and held (data write) in the liquid crystal elements 22 and the capacitors 23, connected to the downstream of the switching transistor 21, via the on-state switching transistors 21 provided for the topmost pixel row.

The operations described above are repeated linear sequentially until the bottommost scanning line YN is selected by the scanning line driving circuit 3. When the bottommost scanning line YN is selected, the data writing period for the first sub-field SF1 is completed. In the sub-field SF1, data once written to the pixels 2 is held until data write is restarted for the next sub-field SF2. For the subsequent sub-fields SF2 and SF3, data write is performed linear sequentially as in the same process for the sub-field SF1. Each of the sub-fields has the same data writing period.

According to the sub-field driving in the first exemplary embodiment, display quality can be enhanced. This is because that, in the sub-fields SF1 to SF3 constituting one frame, a combination of voltage values V is selected in such a manner that the amount of change in data (amount of change in voltages) between adjacent sub-fields is one step level or less. Thus, gradation deviation due to a difference in the amount of voltage change can be suppressed. Moreover, for multiple gradations, gradation inversion and gradation collapse can be effectively reduced or prevented. As a result of this, display quality can be further enhanced by enhancing the gradation characteristics.

Although the amount of change in data between adjacent sub-fields is set to one step level or less in order to minimize the amount of change in data between adjacent sub-fields in the first exemplary embodiment, the amount of change in data between adjacent sub-fields may be set to moderate conditions (for example, two step level or less).

Also, according to the first exemplary embodiment, by using three or more voltage values V, further multi-gradation display can be realized without increasing the number of set sub-fields SF (the number of divisions of one frame), as compared with known sub-field driving using only two voltage values (on-state voltage and off-state voltage). At the same time, since multi-gradation display can be realized without reducing the period of each of the sub-fields, temporal restriction for data write to the pixels 2 can be eased.

In the first exemplary embodiment, the driving voltage. LCOM is set to 0 V (constant voltage) and the polarity of data voltages is inverted in order to AC drive the liquid crystal. However, an AC driving system for the liquid crystal is not limited to this. The driving voltage LCOM may be variably set (two levels) for AC driving. Also, although the example in which the polarity is inverted at every one frame is explained here, the polarity inversion may be performed, for example, for each sub-field or for each scanning period. For a case where the polarity inversion is performed for each sub-field, a combination of voltage values V is selected in such a manner that the absolute value of the amount of change in data (amount of change in voltage) between adjacent sub-fields is lower or equal to a predetermined amount of change. This is also applied to a second exemplary embodiment and a third exemplary embodiment described below.

Also, in the first exemplary embodiment, the example in which a liquid crystal element is used as an electro-optical element is explained. For example, liquid crystal of well-known types including a super twisted nematic (STN) type having a twisted orientation of 180° or more, a bi-stable twisted nematic (BTN) type, a bi-stable type, such as a ferroelectric type, having a memory property, a polymer dispersion type, and a guest host type, in addition to a twisted nematic (TN) type can be widely used. This is also applied to the second and third exemplary embodiments.

Second Exemplary Embodiment

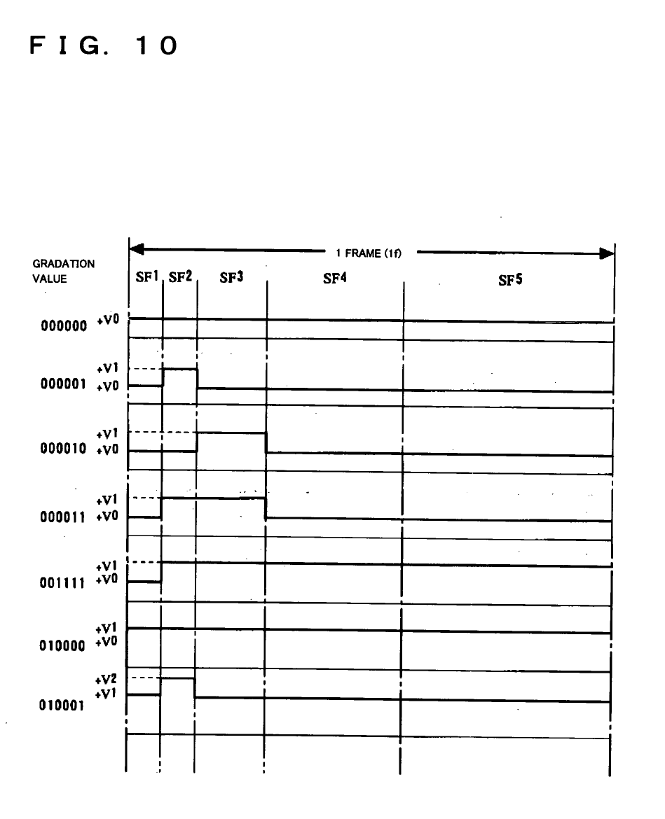

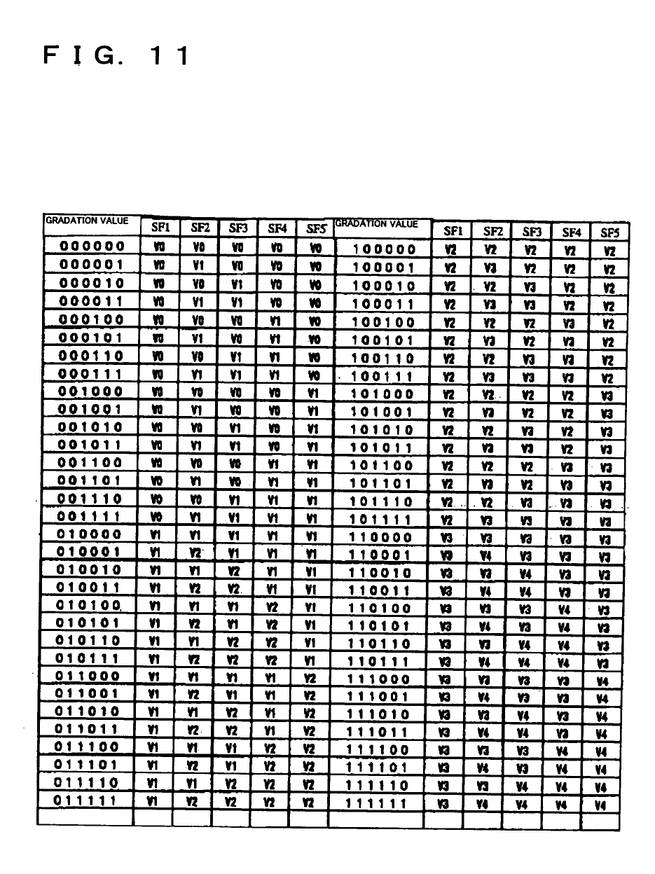

FIG. 10 is an illustration for explaining sub-field driving according to the second exemplary embodiment. In FIG. 10, the relationship between a voltage applied to a pixel and gradation data is shown for each sub-field. The sub-field driving in the second exemplary embodiment realizes 64-gradation display by five sub-fields, SF1 to SF5 using five voltage values V0 to V4. One frame (1 f) is composed of five sub-fields SF1 to SF5. In the relationship with gradation to be displayed, the sub-fields SF1, SF2, SF3, SF4, and SF5 basically have lengths (display periods) provided with weights of 1:1:2:4:8, respectively. However, weighting for the sub-fields SF1 to SF5 may be appropriately adjusted in accordance with the characteristics of liquid crystal. As shown in a voltage setting table in FIG. 11, a combination of voltages for the series of sub-fields SF1 to SF5 is selected from among the five voltage values V0 to V4 in accordance with 6-bit gradation data D0 to D5. The voltage value V0 is a complete off-state voltage and the voltage value V4 is a complete on-state voltage. Also, the medium voltage values V1 to V3 are set in such a manner that the transmittance changes at substantially regular intervals in the area between the threshold voltage Vth1 and the saturation voltage Vth2 shown in FIG. 2. (The voltage values V1 to V3 may be set in such a manner that the transmittance changes nonlinearly. Accordingly, setting of level values (voltage values) can be flexibly applied to various types of liquid crystal.)

In the sub-field driving in the second exemplary embodiment, the combination of the voltage values V is also selected in such a manner that the amount of change in voltages between adjacent sub-fields is one step level or less. Thus, display quality can be further enhanced by enhancing the gradation characteristics, as in the first exemplary embodiment. Also, multi-gradation display can be realized without reducing the period of each of the sub-fields and temporal restriction for data write can be eased. Also, the number of display gradations equal to the first exemplary embodiment can be realized by the number of set voltage values that is smaller than the first exemplary embodiment. For AC driving similar as in the first exemplary embodiment, positive voltages V0 to V4 and negative voltages −V0 to −V4 are used.

Third Exemplary Embodiment

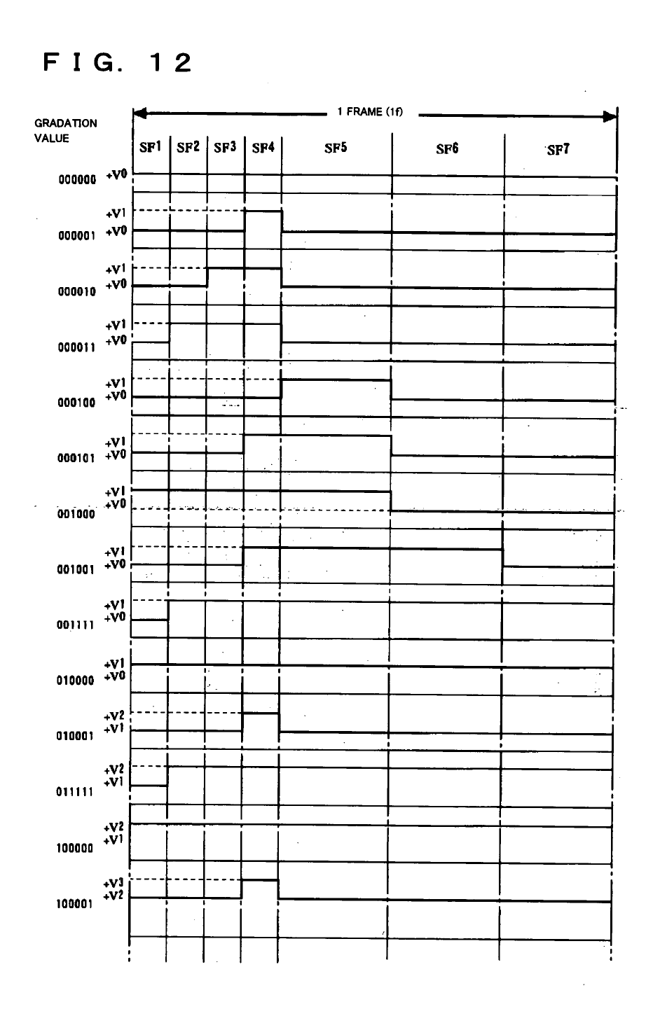

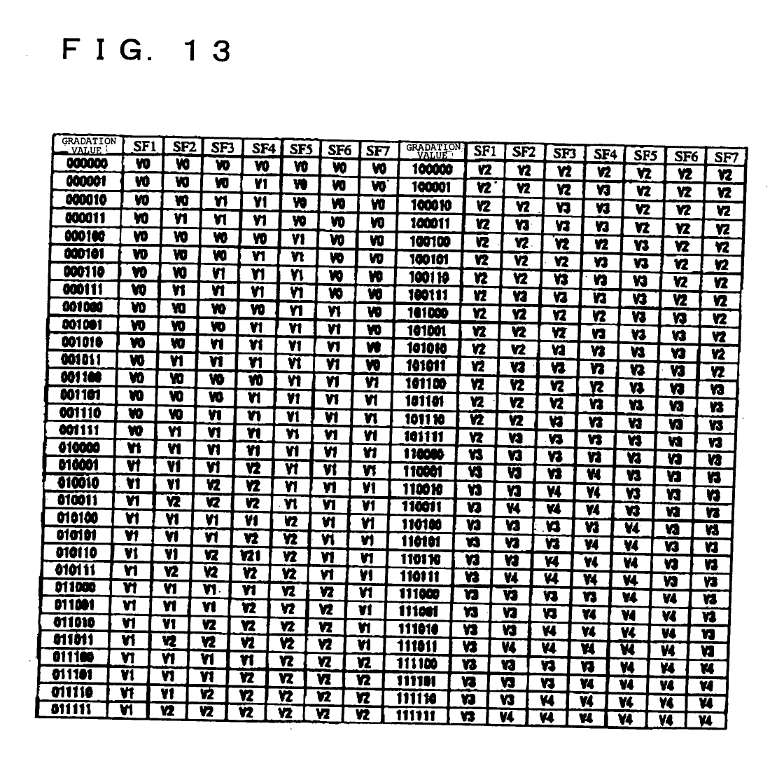

FIG. 12 is an illustration for explaining sub-field driving according to the third exemplary embodiment. In FIG. 12, the relationship between a voltage applied to a pixel and gradation data is shown for each sub-field. The sub-field driving in the third exemplary embodiment realizes 64-gradation display by seven sub-fields SF1 to SF7 using five voltage values V0 to V4. One frame (1 f) is composed of seven sub-fields, SF1 to SF7. In the relationship with gradation to be displayed, the sub-fields SF1, SF2, SF3, SF4, SF5, SF6, and SF7 basically have lengths (display periods) provided with weights of 1:1:1:1:4:4:4, respectively. However, weighting for the sub-fields SF1 to SF7 may be appropriately adjusted in accordance with the characteristics of liquid crystal. As shown in a voltage setting table in FIG. 13, a combination of voltages for the series of sub-fields SF1 to SF7 is selected from among the five voltage values V0 to V4 set as in the second exemplary embodiment, in accordance with 6-bit gradation data D0 to D5.

In the sub-field driving in the third exemplary embodiment, the combination of the voltage values V is also selected in such a manner that the amount of change in voltages between adjacent sub-fields is one step level or less. Thus, display quality can be further enhanced by enhancing the gradation characteristics, as in the first exemplary embodiment. Also, multi-gradation display can be realized without reducing the period of each of the sub-fields and temporal restriction for data write can be eased. For AC driving similar as in the first exemplary embodiment, positive voltages V0 to V4 and negative voltages −V0 to −V4 are used.

Fourth Exemplary Embodiment

In a fourth exemplary embodiment, an example in which an electro-optical element is applied to an organic electronic luminescence (EL) element, which is a typical current-driven element that is driven by a current flowing in itself, is explained. Even for a case where the organic EL element is used, the basic structure of the electro-optical device is similar as shown in FIG. 4. Driving systems for active matrix display using organic EL elements are classified broadly into a voltage program system and a current program system. Here, the voltage program system will be described. The “voltage program system” is a system to supply data to a data line on a voltage basis.

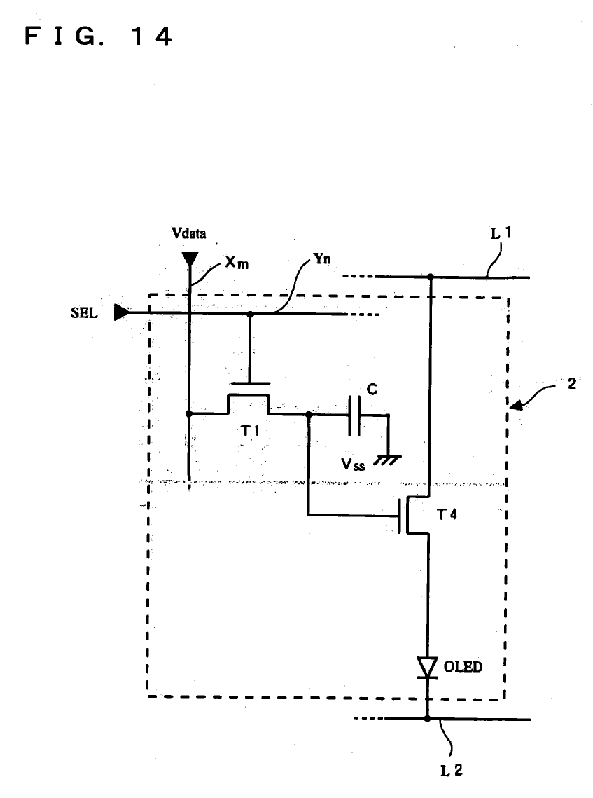

FIG. 14 is an equivalent circuit schematic, according to the fourth exemplary embodiment, showing an example of one of the pixels 2 of the voltage program system using the organic EL element. Each of the pixels 2 includes an organic EL element OLED, two transistors, a switching transistor T1 and a driving transistor T4, and a capacitor C to hold data. The gate of the switching transistor T1 is connected to one of the scanning lines Yn to which a scanning signal SEL is supplied, and the drain of the switching transistor T1 is connected to one of the data lines Xm to which a data voltage Vdata is supplied. The data voltage Vdata is a voltage value V set as in the exemplary embodiments described above. The source of the switching transistor T1 is commonly connected to one electrode of the capacitor C and to the gate of the driving transistor T4, which is a pattern of driving elements. A potential Vss is applied to the other electrode of the capacitor C, and the drain of the driving transistor T4 is connected to a first power line L1 set at a power voltage Vdd. The source of the driving transistor T4 is connected to the anode (positive electrode) of the organic EL element OLED. The cathode (negative electrode) of the organic EL element OLED is connected to a second power line L2 set at a voltage Vss, which is lower than the power voltage Vdd.

The process to control the one of the pixels 2 shown in FIG. 14 will be described. In a period when the scanning signal SEL is at H level, the data voltage Vdata supplied to the one of the data lines Xm is applied to the one electrode of the capacitor C, and an electric charge corresponding to the data voltage Vdata is accumulated in the capacitor C. Then, since a gate voltage Vg is applied to the gate of the driving transistor T4 due to the electric charge accumulated in the capacitor C, the driving transistor T4 flows a driving current corresponding to the gate voltage Vg to its own channel. As a result of this, the organic EL element OLED provided in a current path of the driving current emits light at a brightness corresponding to the driving current, so that gradation display of the one of the pixels 2 is performed.

As described above, in the fourth exemplary embodiment, effects similar to those of the exemplary embodiments described above can also be achieved by the electro-optical device in which the pixels 2 each including the organic EL element OLED are used and data is written to the pixels 2 by the voltage program system.

Fifth Exemplary Embodiment

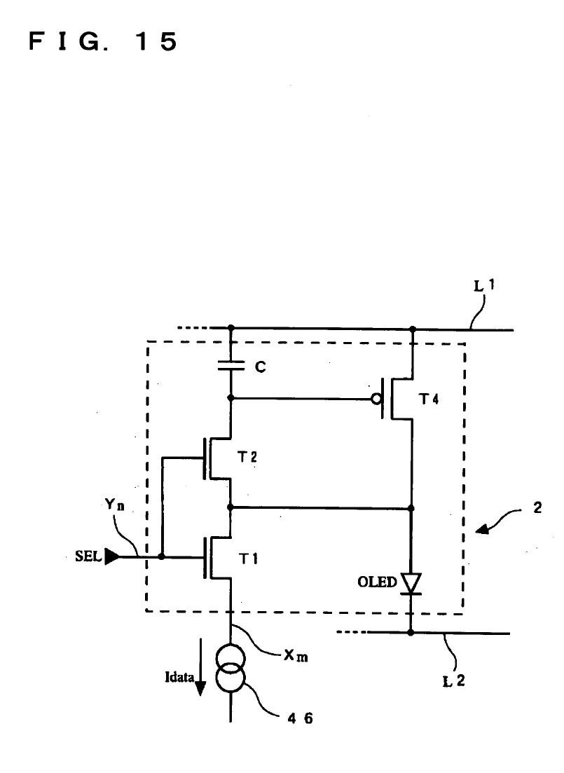

In a fifth exemplary embodiment, an organic EL element is used as an electro-optical element and data write to the pixels 2 is performed by a current program system. The “current program system” is a system to supply data to a data line on a current basis. The basic structure of the electro-optical device according to the fifth exemplary embodiment is similar as shown in FIG. 4. However, the data line driving circuit 4 includes a variable current source 46 (see FIG. 15) to convert a voltage value (data voltage Vdata) V set for each of the sub-fields SF into a data current Idata. The data line driving circuit 4 outputs the converted data current Idata to each of the data lines Xm. With such conversion, three or more level values (voltage values) are consequently converted into current values, so that data is supplied to the pixels 2 at current levels.

FIG. 15 is an equivalent circuit schematic, according to the fifth exemplary embodiment, showing an example of one of the pixels 2 of the current program system using the organic EL element. Each of the pixels 2 includes an organic EL element OLED, three transistors, a first switching transistor T1, a second switching transistor T2, and a driving transistor T4, and a capacitor C. The gate of the first switching transistor T1 is connected to one of the scanning lines Yn to which a scanning signal SEL is supplied, and the source of the first switching transistor T1 is connected to one of the data lines Xm to which a data current Idata is supplied. The drain of the first switching transistor T1 is commonly connected to the source of the second switching transistor T2, to the drain of the driving transistor T4, and to the anode of the organic EL element OLED. The gate of the second switching transistor T2 is connected to the one of the scanning lines Yn, to which the scanning signal SEL is supplied, as in the first switching transistor T1. The drain of the second switching transistor T2 is commonly connected to one electrode of the capacitor C and to the gate of the driving transistor T4. The other electrode of the capacitor C and the source of the driving transistor T4 are commonly connected to a first power line L1 set at a power voltage Vdd. In contrast, the cathode of the organic EL element OLED is connected to a power line L2 set at a voltage Vss.

The process to control the one of the pixels 2 shown in FIG. 15 will be described. In a period when the scanning signal SEL is at H level, the switching transistors T1 and T2 are turned on. Thus, the one of the data lines Xm is electrically connected to the drain of the driving transistor T4, and the driving transistor T4 is subjected to diode connection in which the gate and drain thereof are electrically connected to each other. The driving transistor T4, which also functions as a programming transistor, flows the data current Idata supplied from the one of the data lines Xm to its own channel, and generates a gate voltage Vg corresponding to the data current Idata in its own gate. As a result of this, an electric charge corresponding to the generated gate voltage Vg is accumulated in the capacitor C connected to the gate of the driving transistor T4, and data is thus written. Then, when the scanning signal SEL falls to L level, the switching transistors T1 and T2 are turned off. Thus, the one of the data lines Xm is electrically disconnected from the drain of the driving transistor T4. However, since the gate voltage Vg is applied to the gate of the driving transistor T4 due to the electric charge accumulated in the capacitor C, the driving transistor T4 keeps flowing a driving current corresponding to the gate voltage Vg to its own channel. As a result of this, the organic EL element OLED provided in a current path of the driving current emits light at a brightness corresponding to the driving current, so that gradation display of the one of the pixels 2 is performed.

As described above, in the fifth exemplary embodiment, effects similar to those of the exemplary embodiments described above can also be achieved by the electro-optical device in which the pixels 2 each including the organic EL element OLED are used and data is written to the pixels 2 by the current program system. Since voltage to current conversion is performed in the data line driving circuit 4, three or more level values (voltage values) are consequently set as current values, so that data is supplied to the pixels 2 at current levels. In this case, although the current values, as level values, may be set in such a manner that the optical characteristics (brightness) of the organic EL element OLED change at substantially regular intervals, the current values may be set in such a manner that the optical characteristics of the organic EL element OLED change nonlinearly.

Also, the driving system itself in which data written to the pixels 2 each including the organic EL element OLED is performed by the current program system is new. Thus, for the sub-field driving in the fifth exemplary embodiment, a structure in which two values (on-state value and off-state value) are set as level values for data supplied to the pixels 2 is also new. This structure provides an advantage that there is no need to significantly change the data conversion system and the data line driving system in each of the exemplary embodiments described above, by setting the level values by voltage levels based on the premises that voltage to current conversion is performed.

Although a liquid crystal element and an organic EL element are explained by way of examples in the exemplary embodiments described above, the present invention is not limited to them. The present invention is widely applicable to a digital micromirror device (DMD) and various electro-optical elements using fluorescence and the like by plasma emission and electron emission.

Also, the electro-optical device according to each of the exemplary embodiments described above is capable of being mounted on various electronic apparatuses including a television set, a projector, a portable telephone set, a portable terminal, a mobile computer, a personal computer, and the like. By providing the electro-optical device described above in such electronic apparatuses, the commercial value of the electronic apparatuses can be further increased, and thus commodity appeal of the electronic apparatuses in the market can be increased.

Advantages

In the present invention, a combination of level values (voltage values or current values) is selected from among three or more level values in such a manner that the amount of change in data (data voltages or data currents) between adjacent sub-fields is a predetermined amount of change or less. Thus, gradation deviation caused by a difference in the amount of data change can be suppressed, and gradation inversion and gradation collapse can be effectively prevented. As a result of this, display quality can be further enhanced by enhancing the gradation characteristics.

What is claimed is:

1. A driving method for an electro-optical device that performs gradation display of pixels by using a plurality of sub-fields defined by dividing a predetermined period, the driving method comprising:
setting level values, as data for the corresponding sub-fields that is supplied to the pixels, by selecting the level values from among three or more different level values in accordance with gradation data in such a manner that the absolute value of the amount of change in data between adjacent sub-fields is a predetermined amount of change or less; and
performing the gradation display of the pixels by supplying the data set for the corresponding sub-fields to the pixels.

2. A driving method for an electro-optical device that performs gradation display of pixels by using a plurality of sub-fields defined by dividing a predetermined period, the driving method comprising:
setting level values, as data for the corresponding sub-fields that is supplied to the pixels, by selecting the level values from among three or more different level values in accordance with gradation data in such a manner that the level values are adjacent to each other; and
performing the gradation display of the pixels by supplying the data set for the corresponding sub-fields to the pixels.

3. A driving method for an electro-optical device that performs gradation display. of pixels by using a plurality of sub-fields defined by dividing a predetermined period, the driving method comprising:
selecting level values, as data for the corresponding sub-fields that is supplied to the pixels, from among three or more different level values in accordance with gradation data and of changing the level values within the adjacent level values in accordance with an increase of gradation values defined by the gradation data; and
performing the gradation display of the pixels by supplying the data set for the corresponding sub-fields to the pixels.

4. The driving method for an electro-optical device according to claim 1, the data being a data voltage, and the level values being set by voltage values.

5. The driving method for an electro-optical device according to claim 1, the data being a data current, and the level values being set by current values.

6. A driving method for an electro-optical device that performs gradation display of pixels by using a plurality of sub-fields defined by dividing a predetermined period, the driving method comprising:
setting level values, as data for the corresponding sub-fields that is supplied to the pixels, by selecting the level values from among a plurality of different level values in accordance with gradation data;
writing the data to the pixels by supplying the data set for the corresponding sub-fields to the pixels by current levels; and
performing the gradation display of the pixels by setting driving currents corresponding to the data written to the pixels and by supplying the set driving currents to electro-optical elements that emit light at brightnesses corresponding to the driving currents.

7. An electro-optical device that performs gradation display of pixels by using a plurality of sub-fields defined by dividing a predetermined period, the electro-optical device comprising:
a plurality of scanning lines;
a plurality of data lines;
a plurality of pixels provided in accordance with crossing of the scanning lines and the data lines;
a scanning line driving circuit that selects one of the scanning lines corresponding to one of the pixels to which data is written by outputting a scanning signal to the one of the scanning lines;
a data conversion circuit that sets level values, as the data for the corresponding sub-fields, the data being generated by converting gradation data, by selecting the level values from among three or more different level values in such a manner that the amount of change in data between adjacent sub-fields is a predetermined amount of change or less; and
a data line driving circuit that cooperates with the scanning line driving circuit and that outputs the data for the corresponding sub-fields, the data being generated by the data conversion circuit, to one of the data lines corresponding to the one of the pixels to which the data is written.

8. The electro-optical device according to claim 7, the predetermined amount of change being one step level corresponding to the amount of change between the level values that are adjacent to each other.

9. An electro-optical device that performs gradation display of pixels by using a plurality of sub-fields defined by dividing a predetermined period, the electro-optical device comprising:
a plurality of scanning lines;
a plurality of data lines;
a plurality of pixels provided in accordance to crossing of the scanning lines and the data lines;
a scanning line driving circuit that selects one of the scanning lines corresponding to one of the pixels to which data is written by outputting a scanning signal to the one of the scanning lines;
a data conversion circuit that sets level values, as the data for the corresponding sub-fields, the data being generated by converting gradation data, by selecting the level values from among three or more different level values in such a manner that the level values are adjacent to each other; and
a data line driving circuit that cooperates with the scanning line driving circuit and outputs the data for the corresponding sub-fields, the data being generated by the data conversion circuit, to one of the data lines corresponding to the one of the pixels to which the data is written.

10. An electro-optical device that performs gradation display of pixels by using a plurality of sub-fields defined by dividing a predetermined period, the electro-optical device comprising:
a plurality of scanning lines;
a plurality of data lines;
a plurality of pixels provided in accordance to crossing of the scanning lines and the data lines;
a scanning line driving circuit that selects one of the scanning lines corresponding to one of the pixels to which data is written by outputting a scanning signal to the one of the scanning lines;
a data conversion circuit that selects the data for the corresponding sub-fields, the data being generated by converting gradation data, from among three or more different level values and that changes the level values within the adjacent level values in accordance with an increase of gradation values defined by the gradation data; and
a data line driving circuit that cooperates with the scanning line driving circuit and that outputs the data for the corresponding sub-fields, the data being generated by the data conversion circuit, to one of the data lines corresponding to the one of the pixels to which the data is written.

11. The electro-optical device according to claim 7, the data line driving circuit outputting the data for the corresponding sub-fields to the one of the data lines by voltage levels.

12. The electro-optical device according to claim 11% the one of the pixels including:
a switching element whose conduction is controlled by the scanning signal for the one of the scanning lines; and
an electro-optical element including a pair of electrodes and liquid crystal held between the pair of electrodes, the transmittance or the reflectance of the electro-optical element being changed in accordance with the data supplied by voltage levels from the one of the data lines via the switching element.

13. The electro-optical device according to claim 11, the one of the pixels including:
a switching element whose conduction is controlled by the scanning signal for the one of the scanning lines;
a holding device to hold the data supplied by voltage levels from the one of the data lines via the switching element;
a driving element that generates corresponding driving currents in accordance with the data held by the holding device; and
an electro-optical element that emits light at brightnesses corresponding to the driving currents.

14. The electro-optical device according to claim 7, the data line driving circuit outputting the data for the corresponding sub-fields to the one of the data lines by current levels.

15. The electro-optical device according to claim 14, the one of the pixels including:
a switching element whose conduction is controlled by the scanning signal for the one of the scanning lines;
a holding device to hold the data supplied by current levels from the one of the data lines via the switching element as data of voltage levels;
a driving element that generates corresponding driving currents in accordance with the data held by the holding device; and
an electro-optical element that emits light at brightnesses corresponding to the driving currents.

16. An electro-optical device that performs gradation display of pixels by using a plurality of sub-fields defined by dividing a predetermined period, the electro-optical device including:
a plurality of scanning lines;
a plurality of data lines;
a plurality of pixels provided in accordance to crossing of the scanning lines and the data lines, each of the pixels including a holding device to hold data, a driving element that sets corresponding driving currents in accordance with the data held by the holding device; and an electro-optical element that emits light at brightnesses corresponding to the set driving currents;
a scanning line driving circuit that selects one of the scanning lines corresponding to one of the pixels to which the data is written by outputting a scanning signal to the one of the scanning lines;
a data conversion circuit that sets level values, as data for the corresponding sub-fields that is supplied to the pixels, by selecting the level values from among a plurality of level values of different voltage values in accordance with gradation data; and
a data line driving circuit that cooperates with the scanning line driving circuit and that outputs, by current levels, the data of voltage levels for the corresponding sub-fields, the data being generated by the data conversion circuit and being converted into data of current levels, to one of the data lines corresponding to the one of the pixels to which the data is written.

17. An electronic apparatus provided with the electro-optical device as set forth in claim 7.
